(19) United States
(12) Patent Application Publication
(10) Pub. No.: US 2012/0046019 A1
(43) Pub. Date: Feb. 23, 2012

(54) SYSTEM, METHOD AND COMPUTER READABLE MEDIUM FOR RESTRICTING MOBILE DEVICE SERVICES

(76) Inventors: JOHN FRANK RODKEY, JR., Missouri, TX (US); Ryan Scott Rodkey, Sugarland, TX (US); Darren Lynn, Sugarland, TX (US); David Lynn Hickey, Rosharon, TX (US)

(21) Appl. No.: 12/859,088

(22) Filed: Aug. 18, 2010

(51) Int. Cl. H04M 3/00

(52) U.S. Cl. 455/418

(57) ABSTRACT

In a mobile communications network one or more altered service zones may be defined. When a location aware mobile device enters an altered service zone, an application executing in the mobile device can alter the services of the device that are available to users. In one example, text or other screen-intensive services of a mobile device may be restricted or altered to voice based services as a user of the device drives through a school zone.

### FIELD OF THE INVENTION

This disclosure relates to mobile communications systems and applications that can execute in mobile communications environments, in particular within mobile devices.

### BACKGROUND OF THE INVENTION

Laws that have been enacted in many cities are prohibiting the use of mobile devices, such as cellular phones, in certain areas, such as school zones during school hours, for voice and/or text communications. However, policing of these laws is difficult, while flouting of these laws can endanger lives.

There are numerous other scenarios where restricted mobile services are required that rely on the user to respect the request to not use their mobile device(s). Such scenarios may include the use of devices at airport check-ins, customs areas, airplanes, hospitals, doctor's waiting rooms, etc. Another scenario would include the use of devices before, during or after a hurricane, tornado, snowstorm, flood, terrorist event and other manmade or non-manmade events

As such, what is a required is an improved system, method and computer readable medium for restricting mobile device usage in certain locations and/or situations.

### SUMMARY OF THE INVENTION

In one aspect of the disclosure, there is provided a method for altering the services of a mobile communications device comprising determining when the mobile communications device is in an altered service zone and altering at least one service of the mobile communications device while the mobile communications device is in the altered service zone.

In one aspect of the disclosure, there is provided a mobile communications device comprising an application executable within the mobile communications device. The application may be configured to determine when the mobile communications device is within an altered service zone and alter one or more services of the mobile communications device when the mobile communications device is within the altered service zone.

In one aspect of the disclosure, there is provided a computer-readable medium comprising computer-executable instructions for execution by a processor of a mobile communications device, that, when executed, cause the processor to receive a notification from a server, and alter one or more services of the mobile communications device.

### BRIEF DESCRIPTION OF THE DRAWINGS

Reference will now be made, by way of example only, to specific embodiments and to the accompanying drawings in which:

FIG. 1 shows a system for altering mobile device services;

FIG. 2 shows a process for altering mobile device services;

FIG. 3 shows a system in which boundary definitions are provided to a mobile device;

FIG. 4 shows a process for downloading boundary definitions to a mobile device;

FIG. 5 shows a system where an altered service zone is determined with reference to a reference point;

FIG. 6 shows a processor and memory of a mobile device; and

FIG. 7 shows an instruction set executable on the processor of the mobile device of FIG. 6.

### DETAILED DESCRIPTION OF THE INVENTION

The following description contains numerous conjectural embodiments. These embodiments can assist to broaden the disclosure and correspondingly, the scope of the claims. The embodiments should be reviewed closely for feasibility and additional enabling description, such as more detailed information related to the steps in the embodiments. Also, additional features, processes and components should be added where appropriate. Please also identify what is the most likely implementation so that we can make sure that it is fully enabled and so that the claims can be focused to this embodiment.

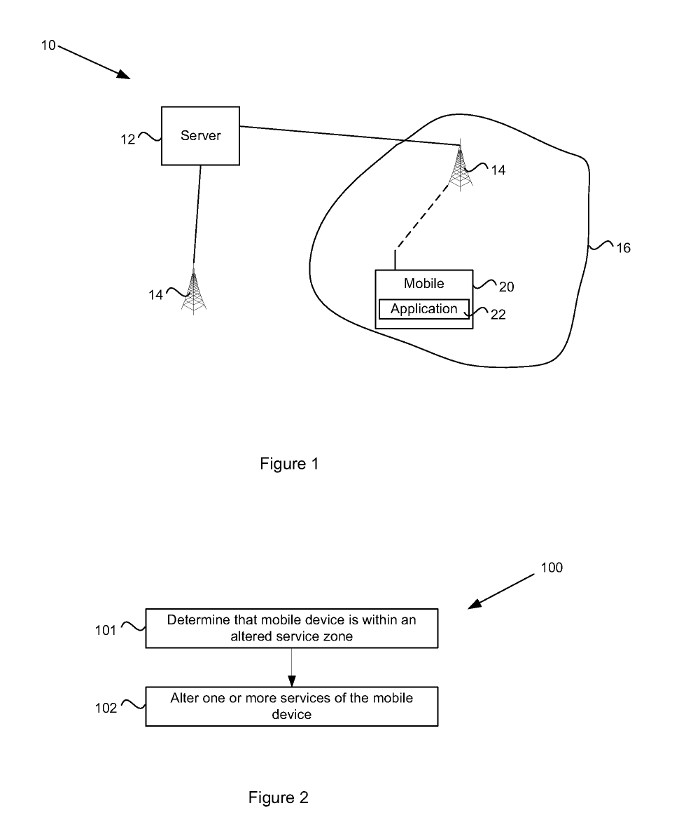

In FIG. 1, there is shown a system 10 in accordance with an embodiment of the disclosure. The system 10 includes a server 12 that provides mobile telecommunication services to one or more mobile devices 20 via one or more base stations 14 to define a telecommunications network. Within a geographic area of the network, there may be defined one or more special service zones 16 in which particular services may be restricted, altered or excluded.

In the flowchart 100 of FIG. 2, there is shown a method for operating the mobile device as it moves through the system 10. At step 101, the device 20 is determined to be within an altered service zone 16 which causes at least one service of the mobile communications device to be altered (step 102). With reference to FIG. 1, the mobile device 20 may execute an internal application 22 for altering the availability of services based on the device's location. The application 22 may be preconfigured into the device or may be downloaded to the device when required. The application 22 may be coded to be device vendor specific so that the application may interface with other applications of the device, such as for access to directories and settings, access to voice and messaging services and access to ancillary functions such as games, galleries, cameras, voice recorders, etc.

The application 22 determines when the mobile device 20 has entered an altered zone 16, has reached a predetermined rate of motion or combinations thereof, and alters the availability of services accordingly. In one embodiment, the services to be altered may be transmission/reception services. That is, the application 22 may prevent the mobile device 20 from communicating with the server 12 and/or the application 22 may prevent the server 12 from communicating with the mobile device 20. In one embodiment, the application 22 will notify server 12 when vehicle has entered an altered service zone 16, reached a predetermined rate of motion or combinations thereof, and inform server to cease communication with mobile device 20 until mobile device 20 has vacated the altered service zone 16, lowered its rate of motion below the predetermined rate of motion or combinations thereof. In another embodiment, the application 22 may disable all network and wireless capabilities when mobile device 20 is in the altered service zone 16, reached a predetermined rate of motion or combinations thereof, preventing communication between server 12 and the mobile device 20. The communications may be prevented for all services or particular subsets of services, such as voice services, text messaging services, or notification services such as blogs, twitter, facebook, etc, that might require a user to provide excess attention to the on screen display.

As an alternative to limiting Tx/Rx services at the device end, these services may be limited at the server 12. That is, the server 12 may receive a communication request from or to the device 20, determine that the device 20 is within an altered service zone such as zone 16, and prevent the communication request from reaching the target device (the device 20 for incoming communications or another device for outgoing communications and requests). In this case, the application 22 within the device 20 may not need to be present.

While limiting the transmission/reception services of a mobile device may prevent some types of communications, other services within the mobile device 20 may still draw excess attention from the user. Thus, the application 22 may alter or otherwise limit other services of the mobile device. For example, text messaging applications may be restricted so that a user is unable to type a new message or read existing messages. Other screen and/or keypad based services such as games, and gallery based services such as reviewing images or using a camera function may also be prevented.

When the mobile device 20 has entered an altered service zone such as zone 16, the application 22 may activate an alert such as a characteristic ring tone, vibration or on screen display that alerts the user that an altered service zone has been entered. In one embodiment, the keypad may be made at least partially inactive (larger buttons such as the major selection buttons and call answering, cancel buttons etc may be left operative) and any onscreen buttons may be grayed out in a manner that quickly indicates to a user that functions associated with those buttons are inactive. Similarly, when the mobile device 20 departs the altered service zone, a second alert may be activated to notify the user that services have been restored.

In one embodiment, the application may receive and store messages from the server but may override any user prompts such as the onscreen display, ring tones or device vibrations so that the useris not alerted to the receipt of the message. When the device 20 leaves the altered service zone 16 and normal service is restored, the application may activate whatever user prompts are set for communicating to the user that communications have been received.

Different altered service zones may be categorized with different altered service levels. For example, a school zone may allow voice communications but no text or keypad intensive services such as text messaging, whereas a zone defined within a public or private changing room may allow all communications services but may disable camera functions of a mobile device. The application 22 may be configured to determine the altered service zone category and to limit or alter services of the mobile device appropriately.

The mobile device 20 may be inherently location aware, such as where the device 20 is fitted with a GPS, accelerometer or similar module. Alternatively, location awareness may be derived from interactions with other network elements, such as by triangulation from base stations, Received Signal Strength Indication (RSSI) techniques, and/or Location Based Services (LBS). Alternatively or in addition, the software application may be configured with a tracking-based application if the phone does not currently support one. That is, a mobile device that is not inherently location aware may be made location aware by way of the application that receives location data from a server and/or receives service altering instructions from the server.

The device 20 may determine whether or not it is within an altered service zone by continually or periodically communicating a position to the server 12. The server 12 receives the position information, determines whether the position coincides with one or more altered service zones and if so, sends a notification when the device 20 enters an altered service zone 16. The notification may indicate various information including a boundary of the zone 16, time entered, and a category of the zone.

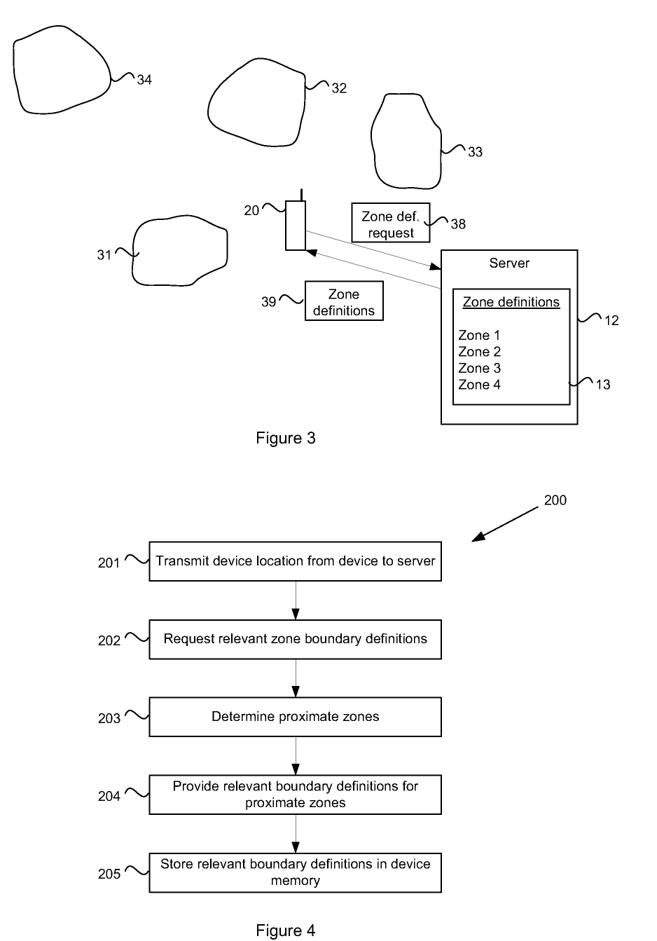

In one embodiment, zone boundaries may be stored within a memory of the device 20 so that a location aware device may continually or periodically check its location against the stored boundaries and prevent or alter available services whenever the device is within a boundary. In order to reduce the memory requirements of the device for storing boundary information, the device 20 may download only relevant zone boundaries. For example, as shown in FIG. 3, the server 12 may store zone definitions 13 that include a plurality of zone boundaries and associated service information. The process is shown in the flowchart 200 of FIG. 4. As a device 20 moves through a geographic region, it may periodically transmit its position to the server 12 (step 201), e.g. every 10 minutes, and request 38 any relevant zone boundaries (step 202). By comparison of the device's position to some proximity thresholds, the server 12 is able to determine that the device is proximate to the zones 31, 32 and 33 (step 203). By the same comparison, the server 12 is able to determine that the zone 34 is not relevant for the device's current position. The server 12 responds to the device's request by transmitting the relevant zone boundary definitions 39 (step 204), i.e. for the zones 31, 32 and 33. The boundary definitions are received and stored in a memory of the device 20 (step 205) and allow the device to internally determine when the device 20 enters any altered service zones. The boundary definitions may include a category of the altered service zone or other information that allows the device to determine what services are to be restricted or altered for each zone. As the device position changes, the device may re-transmit its position to the server and request an updated set of relevant boundary definitions.

Whenever a device 20 determines that is within an altered service zone, either by receiving a notification from the server, by an internal determination, or by other means, information may be displayed on a display of the device 20, an alert may sound, and/or a voice message may be played to the user, so that the user is made aware of what services are available and what services are restricted. A similar message may be displayed and/or played whenever it is determined that the device 20 has departed an altered service zone.

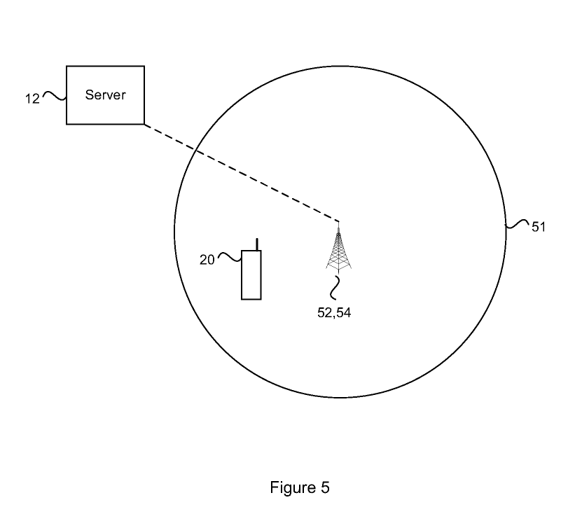

As shown in FIG. 5, a zone boundary 51 may be defined relative to a reference 52, e.g. as a proximity to a transmitter 54. In one embodiment, the reference 52 may be a base station of the mobile communications network such that any device communicating through that base station is provided with restricted or altered service access. In alternative embodiments, the reference 52 may be a local area transmitter configured for peer to peer communications with mobile devices such that the device 20 is able to communicate directly with the reference 52, thereby enabling the device to alter the available services of the device without reference to the server 12. Such local transmitters may be provided in locations where restricted device service is required, such as in public libraries, change rooms, movie theatres, concert halls, airports, etc. and may be used to restrict an array of services such as voice, text, camera functions, blogging services etc.

In one embodiment, the reference 52 may be a moving reference. For example, vehicles may be configured with a location transmitter that transmits the location of the vehicle to the server 12. The server receives the location of a mobile device and Compares it to the position of the vehicle location transmitter. If the mobile device is within a threshold distance of the transmitter, say, 2 meters, then the server may block or alter service access.

As an alternative to server based communications, the moving transmitter may be configured for peer to peer communications with mobile devices as described above, such that the mobile application 22 of the mobile device 20 may determine whether the device 20 is within a threshold distance of the moving transmitter and restrict or alter the device services accordingly.

In one embodiment, the application 22 and/or server 12 may be configured to determine the type of transport the device 20 is in and thus provide users of those devices with an ability to continue to use the device services. For example, if the transport is believed to be a bus, then text messaging may be allowed by the passengers but not the driver. The ability to determine the driver's device vs. the passengers' devices can be performed based on distance from the devices to one another (in a bus, the driver is in a specific location), based on movement of the device relative to a reference point (if devices are entering and exiting the transport in various locations, those locations should be appropriate for using the service but if a single device remains in a certain position for a period of time in the transport, that device would be associated with the driver and thus would not be able to use the service), or based on proximity to the reference point e.g. where the reference point is located within a driver area.

As will be apparent from the foregoing, the system 10 may be used to limit a driver's access to device services whilst a driver is passing through an altered service zone, such as a school zone. In one embodiment, the altered service zone may have time limits such that the service restrictions only apply at specific hours, e.g. school hours in a school zone, or during event hours for various other events. In one embodiment, when a device is within an altered service zone where text messages are prevented, the opening of a text message may divert the text message from a screen display of the text to a voice rendition of the text message. Also, if a user is texting and then enters a text service exclusion zone before the text is complete, the software application may automatically shift to a voice command state allowing the user to complete the message with voice commands.

In order to ensure that only car occupant phones are restricted, the system may use a correlation between the location of the device, the school zone and a reference point (e.g. of the car). That is, all three aspects must be co-located in order for the altered services to apply. Also, restricted services may only apply to devices located on roadways and/or to moving devices, so that stationary phones or phones located on pathways, e.g. by pedestrians, do not have restricted access. Movement of devices may be determined by successive location readings, by an internal accelerometer of the device or by other appropriate means.

Whilst restricting mobile device services for drivers was a primary motivation for the system 10, other applications of the system 10 will be apparent to a person skilled in the art. In one specific example, a school zone may also be used to limit services for students. That is, during class hours, exam times, etc., the mobile application 22 within a device may be used to prevent students from communicating by voice and/or text and/or from accessing web services. The application 22 may also prevent a student from accessing various directories and data storage of the device which might store cheat notes or other information that could be used during student exams. For such embodiments, the server 12 may provide an administrator function that allows an administrator to log into the server 12, e.g. via a web interface, and set parameters of the altered service zone, such as the hours during which the altered services apply and the types of services that are to be altered, restricted or excluded.

In an alternative embodiment, the system 10 of FIG. 1 may be used to alter available services on a mobile device 20 without regard to a location dependent zone. Under some circumstances, e.g. in a security context, a notification may be sent from the server 12 to mobile devices 20 that restrict or alter the services that a device is able to provide. Such restriction may be provided during an emergency event, for example, to prevent a network overload and/or to ensure that a mobile device is available to receive emergency notifications such as evacuation instructions from authorities.

Where an altered service zone is in operation, a system override may also operate in cases of emergency so that full device services can be quickly restored where required.

While the altered service zones are depicted in the above described embodiments as being in discrete and separate geographic locations, in practice, the altered service zones may overlap. In particular, zones of different categories may overlap such that the affected services of one zone may be different to the affected services of an overlapping zone. Logic rules may be applied by the application and/or by the server to determine what services are available to a mobile device when the device is located in an overlapping portion of multiple altered service zones.

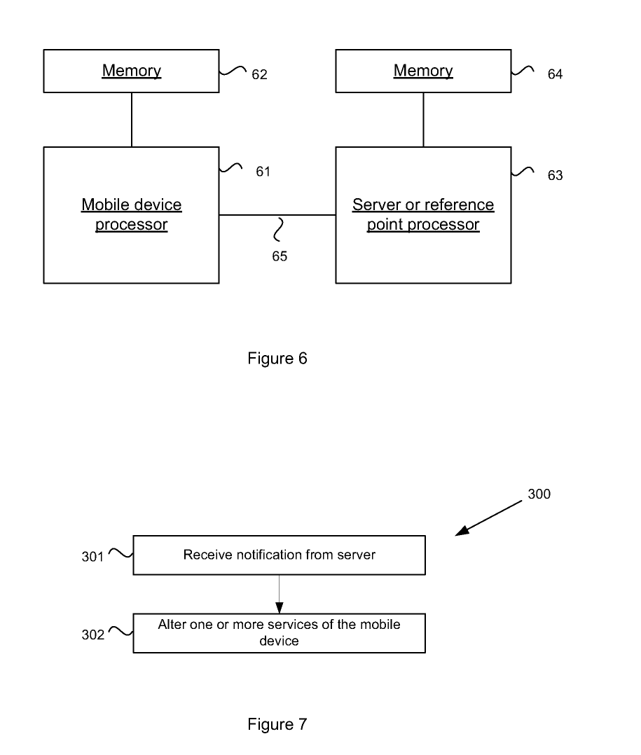

The components of the system 10 may be embodied in hardware, software, firmware or a combination of hardware, software and/or firmware. In a hardware embodiment, the application 22 may be executed on a processor 61 of the mobile device 20 that is operatively associated with, a memory 62 as shown in FIG. 6. The memory 62 may store instructions that are executable on the processor 61. In addition, the memory 62 may store additional information such as the boundary definitions, zone categories and the like. The processor 61 may communicate with a processor 63 of the server or a reference point through wireless communications 65. The server/reference point processor may also be operatively associated with a memory 64. An instruction set 300 that may be executed on the processor 61 is depicted in the flowchart of FIG. 7. Specifically, when executed, the instruction set 300 allows the processor 61 to receive a notification from a server (step 301) and alter one or more services of the mobile communications device (step 302). Specifically, the processor 61 may restrict one or more communications services of the mobile device.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

What is claimed is:

1. A method for altering the services of a mobile communications device comprising;
a. determining when the mobile communications device is in an altered service zone, has reached a predetermined rate of motion or combinations thereof; and
b. altering at least one service of the mobile communications device while the mobile communications device is (a) in the altered service zone, (b) has reached a predetermined rate of motion, or (c) combinations thereof.

2. The method according to claim 1 comprising receiving a notification into the mobile communications device that indicates that the mobile communications device is within an altered service zone.

3. The method according to claim 2 comprising:
determining a location of the mobile communications device; and a) providing the location to a server;
wherein the notification is received from the server.

4. The method according to claim 3 wherein the server is configured to determine whether the mobile communications device is located within an altered service zone.

5. The method according to claim 4 wherein the notification indicates one or more device services that are altered within the altered service zone.

6. The method according to claim 1 comprising:
receiving at least one boundary definition of at least one altered service zone into the mobile communications device; and
determining when the device is within a zone boundary defined by the at least one boundary definition.

7. The method according to claim 1 wherein altering at least one service of the mobile communications device comprises restricting operation of a keypad of the mobile communications device.

8. The method according to claim 1 wherein altering at least one service of the mobile communications device comprises converting a received text message to a voice message and playing the voice message.

9. The method according to claim 1 wherein altering at least one service of the mobile communications device comprises restricting a camera function of the mobile communications device.

10. The method according to claim 1 wherein determining when the mobile communications device is within an altered service zone comprises determining a position of the mobile communications device relative to a reference point.

11. The method according to claim 10 wherein the reference point is a moving reference point.

12. A mobile communications device comprising an application executable within the mobile communications device, the application configured to:
determine when the mobile communications device is within an altered service zone, has reached a predetermined rate of motion or combinations thereof; and
alter one or more services of the mobile communications device when the mobile communications device
a) is in the altered service zone,
b) has reached a predetermined rate of motion, or
c) combinations thereof.

13. The mobile communications device according to claim 12 configured to:
determine a location of the mobile communications device;
communicate the location to a server; and:
receive a notification from the server that the mobile communications device is within an altered service zone.

14. The mobile communications device according to claim 12 configured to determine the location of the mobile communications device relative to a reference point.

15. The mobile communications device according to claim 14 configured to communicate peer to peer with the reference point.

16. The mobile communications device according to claim 12 wherein the application is configured to restrict at least one communication service of the mobile communications device.

17. The mobile communications device according to claim 12 wherein the application is configured to restrict at least one camera function of the mobile communications device.

18. The mobile communications device according to claim 12 wherein the application is configured to produce an alert when the mobile communications device enters the at least one altered service zone.
A computer-readable medium comprising computer-executable instructions for execution by a processor of a mobile communications device, that, when executed, cause the processor to alter one or more services of the mobile communications device.

19. The computer-readable medium according to claim 20 comprising instructions that, when executed by the processor, cause the processor to prevent at least one communication service of the mobile communications device.

20. The computer readable medium according to claim 20 comprising instructions that, when received notification from a server, cause the processor to prevent at least one communication service of the mobile communications device.
